(19) United States
(12) Patent Application Publication
(10) Pub. No.: US 2024/0149963 A1
(43) Pub. Date: May 9, 2024

(54) WEAR RESISTANT COMPONENT

(71) Applicant: KOMATSU LTD., Tokyo (JP)

(72) Inventors: Masayuki OHISHI, Tokyo (JP); Masaharu AMANO, Tokyo (JP); Minoru KATAYAMA, Tokyo (JP)

(73) Assignee: KOMATSU LTD., Tokyo (JP)

(21) Appl. No.: 18/281,436

(22) PCT Filed: Feb. 25, 2022
(86) PCT No.: PCT/JP2022/007975

§ 371 Date: Sep. 11, 2023

(30) Foreign Application Priority Data
Mar. 31, 2021 (JP) 2021-061506

(51) Int. Cl. B62D 55/20; B62D 55/26; E02F 9/28

(52) U.S. Cl. CPC B62D 55/20; B62D 55/26; E02F 9/285; E02F 9/2883

(57) ABSTRACT

A wear resistant component includes a matrix portion made of metal, a core embedded in the matrix portion and having a hardness higher than that of the matrix portion, and a plurality of support members having at least one end exposed from a surface of the matrix portion, extending toward an interior of the matrix portion, and contacting the core at a portion other than the one end to define a position of the core within the matrix portion.

### TECHNICAL FIELD

The present disclosure relates to a wear resistant component.

The present application claims priority based on Japanese Patent Application No. 2021-61506 filed on Mar. 31, 2021, the entire contents of which are incorporated herein by reference.

### BACKGROUND ART

In wear resistant components such as teeth, tooth adapters, and ripping tips of work machines, it has been proposed to place a member of high hardness inside for the purpose of improving wear resistance (see, for example, Japanese Patent Application Laid-Open No. H01-55370 (Patent Literature 1), Japanese Patent Application Laid-Open No. H02-176026 (Patent Literature 2), and Japanese Patent Application Laid-Open No. H09-192819 (Patent Literature 3)).

### CITATION LIST

### Patent Literature

Patent Literature 1: Japanese Patent Application Laid-Open No. H01-55370
Patent Literature 2: Japanese Patent Application Laid-Open No. H02-176026
Patent Literature 3: Japanese Patent Application Laid-Open No. H09-192819

### SUMMARY OF INVENTION

### Technical Problem

As described above, improvement in wear resistance is required for wear resistant components. One of the objects of the present disclosure is to provide a wear resistant component with improved wear resistance.

### Solution to Problem

A wear resistant component of the present disclosure includes: a matrix portion made of metal; a core embedded in the matrix portion and having a hardness higher than that of the matrix portion; and a plurality of support members having at least one end exposed from a surface of the matrix portion, extending toward an interior of the matrix portion, and contacting the core at a portion other than the one end to define a position of the core within the matrix portion.

### Advantageous Effects of Invention

According to the above-described wear resistant component, a wear resistant component with improved wear resistance can be provided.

### BRIEF DESCRIPTION OF DRAWINGS

FIG. 1 is a schematic perspective view of the outline of a track chain member in Embodiment 1.

FIG. 2 is a schematic perspective view showing the internal structure of the track chain member in Embodiment 1.

FIG. 3 is a schematic cross-sectional view showing the internal structure of a projecting portion of the track chain member in Embodiment 1.

FIG. 4 is a schematic cross-sectional view showing the internal structure of the projecting portion of the track chain member in Embodiment 1.

FIG. 5 is a schematic perspective view of the outline of a track chain member in Embodiment 2.

FIG. 6 is a schematic perspective view showing the internal structure of the track chain member in Embodiment 2.

FIG. 7 is a schematic cross-sectional view showing the internal structure of a projecting portion of the track chain member in Embodiment 2.

FIG. 8 is a schematic cross-sectional view showing the internal structure of the projecting portion of the track chain member in Embodiment 2.

FIG. 9 is a schematic perspective view of the outline of a track chain member in Embodiment 3.

FIG. 10 is a schematic perspective view showing the internal structure of the track chain member in Embodiment 3.

FIG. 11 is a schematic cross-sectional view showing the internal structure of a projecting portion of the track chain member in Embodiment 3.

FIG. 12 is a schematic cross-sectional view showing the internal structure of the projecting portion of the track chain member in Embodiment 3.

FIG. 13 is a schematic cross-sectional view showing the internal structure of the projecting portion of the track chain member in Embodiment 3.

FIG. 14 is a schematic perspective view of the outline of a lug bar in Embodiment 4.

FIG. 15 is a schematic perspective view showing the internal structure of the lug bar in Embodiment 4.

FIG. 16 is a schematic cross-sectional view showing the internal structure of the lug bar in Embodiment 4.

FIG. 17 is a schematic cross-sectional view showing the internal structure of the lug bar in Embodiment 4.

FIG. 18 is a schematic perspective view of the outline of a side protector in Embodiment 5.

FIG. 19 is a schematic perspective view showing the internal structure of the side protector in Embodiment 5.

FIG. 20 is a schematic cross-sectional view showing the internal structure of the side protector in Embodiment 5.

FIG. 21 is a schematic cross-sectional view showing the internal structure of the side protector in Embodiment 5.

FIG. 22 is a schematic perspective view of the outline of a tooth in Embodiment 6.

FIG. 23 is a schematic perspective view showing the internal structure of the tooth in Embodiment 6.

FIG. 24 is a schematic plan view showing the internal structure of the tooth in Embodiment 6.

### DESCRIPTION OF EMBODIMENTS

### Outline of Embodiments

A wear resistant component according to the present disclosure includes: a matrix portion made of metal; a core embedded in the matrix portion and having a hardness higher than that of the matrix portion; and a plurality of support members having at least one end exposed from a surface of the matrix portion, extending toward an interior of the matrix portion, and contacting the core at a portion other than the one end to define a position of the core within the matrix portion.

In the wear resistant component according to the present disclosure, the core higher in hardness than the matrix portion is embedded in the matrix portion. The support members define the position of this core within the matrix portion. The hard core being thus held in an appropriate position within the matrix portion by the support members improves wear resistance of the wear resistant component. Thus, the wear resistant component according to the present disclosure can provide a wear resistant component with improved wear resistance.

In the wear resistant component described above, the plurality of support members may include a first support member. The first support member may have a bar shape extending from a first end, which is the one end, to a second end. The first support member may be exposed from a surface of the matrix portion at the first end and contact the core at the second end. This configuration allows the position of the core to be defined by the second end of the first support member.

In the wear resistant component described above, the plurality of support members may include a second support member. The second support member may have a bar shape including a third end, which is the one end, and a fourth end, which is an opposite end to the third end. The second support member may be exposed from the surface of the matrix portion at least at the third end, and may contact the core at a side surface located between the third end and the fourth end. This configuration allows the position of the core to be defined by the side surface located between the third end and the fourth end of the second support member.

In the wear resistant component described above, the plurality of support members may include a third support member. The third support member may include a first portion of a bar shape including a fifth end, which is the one end exposed from the matrix portion, and a sixth end located within the matrix portion, a second portion of a bar shape including a seventh end exposed from the matrix portion and an eighth end located within the matrix portion, and a third portion of a bar shape connecting the sixth end to the eighth end, and contacting the core. This configuration allows the position of the core to be defined by the third portion of the third support member.

In the wear resistant component described above, the first portion and the second portion may be parallel. The third portion may be orthogonal to the first portion and the second portion. This configuration facilitates defining the position of the core by the third portion of the third support member.

In the wear resistant component described above, the plurality of support members may include a fourth support member. The fourth support member may have a bar shape including a ninth end, which is the one end exposed from the matrix portion, and a tenth end located within the matrix portion. A region including the tenth end may be a flange larger in cross-sectional area perpendicular to a longitudinal direction than an adjacent region. The fourth support member may penetrate through the core and contact the core at the flange. This configuration allows the position of the core to be defined by the flange of the fourth support member.

### Specific Embodiments

Specific embodiments of the wear resistant component of the present disclosure will be described below with reference to the drawings. In the drawings referenced below, the same or corresponding portions are denoted by the same reference numerals and the description thereof will not be repeated.

### Embodiment 1

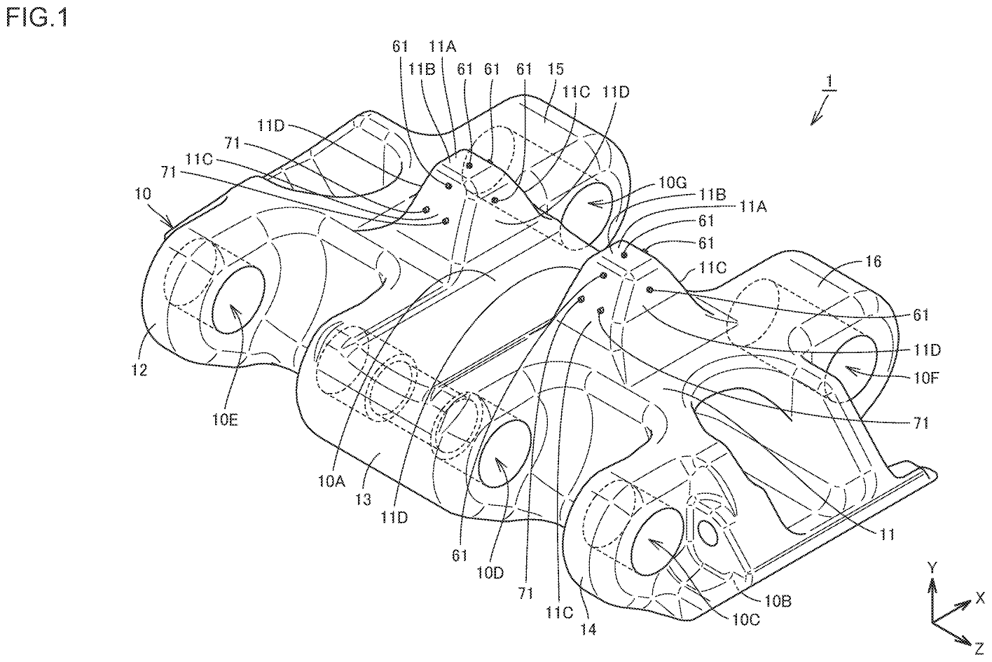

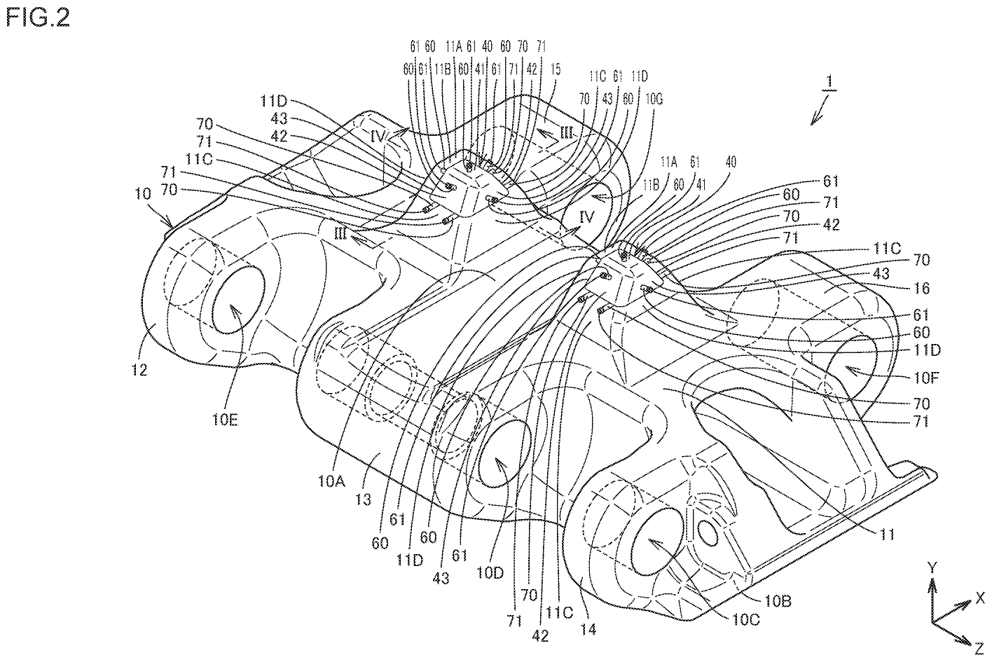

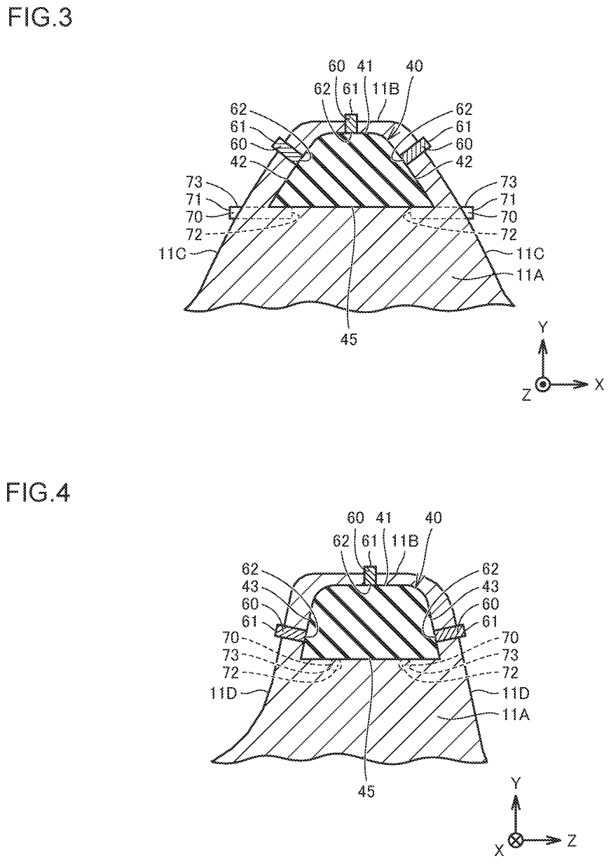

Firstly, a track chain member of Embodiment 1, which is an example of the wear resistant component according to the present disclosure, will be described with reference to FIGS. 1 to 4. FIG. 1 is a schematic perspective view of the outline of the track chain member in Embodiment 1. FIG. 2 is a schematic perspective view showing the internal structure of the track chain member in Embodiment 1. FIG. 2 corresponds to the state of seeing through the interior of the track chain member in FIG. 1. FIGS. 3 and 4 are schematic cross-sectional views showing the internal structure of a projecting portion of the track chain member in Embodiment 1. In FIGS. 1 to 4, the X axis direction corresponds to the rotational direction of a track that is formed with the track chain members connected in series. In FIGS. 1 to 4, the Y axis direction corresponds to the thickness direction of the track chain member. In FIGS. 1 to 4, the Z axis direction corresponds to the width direction of the track chain member. FIG. 3 is a cross-sectional view in the X-Y plane. FIG. 3 is a cross-sectional view along the line III-III in FIG. 2. FIG. 4 is a cross-sectional view in the Y-Z plane. FIG. 4 is a cross-sectional view along the line IV-IV in FIG. 2.

Referring to FIGS. 1 and 2, the track chain member 1 in Embodiment 1 is a track chain member that forms a track with a plurality of such track chain members connected in an annular manner. The track chain member 1 has a plate shape including an inner surface 10A, which is a first flat surface, and a rail surface 10B, which is a second flat surface located on the opposite side in the thickness direction (Y axis direction). The track chain member 1 includes a body portion 11, a first protrusion 12, a second protrusion 13, a third protrusion 14, a fourth protrusion 15, and a fifth protrusion 16. The first protrusion 12, the second protrusion 13, and the third protrusion 14 protrude from the body portion 11 in a first direction along the X axis direction. The fourth protrusion 15 and the fifth protrusion 16 protrude from the body portion 11 in a second direction opposite to the first direction along the X axis direction.

The first protrusion 12 has a through hole 10E formed to penetrate through the first protrusion 12 in the Z axis direction. The second protrusion 13 has a through hole 10D formed to penetrate through the second protrusion 13 in the Z axis direction. The third protrusion 14 has a through hole 10C formed to penetrate through the third protrusion 14 in the Z axis direction. The fourth protrusion 15 has a through hole 10G formed to penetrate through the fourth protrusion 15 in the Z axis direction. The fifth protrusion 16 has a through hole 10F formed to penetrate through the fifth protrusion 16 in the Z axis direction. The track chain members 1 can be arranged side by side in the X axis direction in the state where the fourth protrusion 15 is inserted between the first protrusion 12 and the second protrusion 13, and the fifth protrusion 16 is inserted between the second protrusion 13 and the third protrusion 14. At this time, the through hole 10E, the through hole 10G, the through hole 10D, the through hole 10F, and the through hole 10C are arranged on a line in this order. Connecting members such as bushings and a pin are then inserted into the through holes 10C to 10G to thereby connect the adjacent track chain members 1.

In a region of the inner surface 10A corresponding to the body portion 11, a pair of engagement portions 11A are formed to project from the inner surface 10A in the Y axis direction (thickness direction of the track chain member 1). The engagement portions 11A engage with a sprocket wheel (not shown) of a tracked undercarriage device to receive driving force from the sprocket wheel. In other words, the track chain member 1 is a member that has the function as a shoe and the function as a link of the tracked undercarriage device. The engagement portions 11A engage with the sprocket wheel in the state where earth and sand are prone to enter. The engagement portions 11A thus require high wear resistance.

Details of the structure of the engagement portions 11A will now be described. Referring to FIGS. 2 to 4, the track chain member 1 includes a matrix portion 10, a core 40, and a plurality of support members 60, 70. The matrix portion 10 is made of metal. For the metal constituting the matrix portion 10, cast steel, for example, can be adopted. The cast steel that can be adopted is not particularly limited as long as it has suitable wear resistance. For example, Cr—Mo cast steel, Cr—Mo-V-W cast steel, Cr—Mo—Ni cast steel, high Mn cast steel, boron cast steel, Cr—Mo—V cast steel, high Cr cast steel, or other low alloy cast steel may be adopted. In addition, cast steel having the component composition of carbon steel for machine structural use or alloy steel for machine structural use specified in JIS standard (for example, S45C or SCM435, as well as manganese steel (SMn), chromium steel (SCr), or chromium-molybdenum steel (SCM) containing an equivalent amount of carbon) may be adopted. Furthermore, for the metal constituting the matrix portion 10, cast iron having a higher carbon content than cast steel may be adopted.

A core 40 is embedded in a region of the matrix portion 10 corresponding to an engagement portion 11A. The core 40 has a hardness higher than that of the matrix portion 10. The core 40 may be a sintered body of particles or powder of a hard material such as high speed tool steel, cemented carbide, or the like. Forming of the core 40 prior to sintering may be performed, for example, using a 3D printer. The core 40 may be fabricated using rolling (including special shape rolling), cutting, forging, casting, or other method in place of, or in combination with, sintering. The core 40 may have an overlay formed on its surface, the overlay containing particles or powder of high speed tool steel, cemented carbide, or the like.

The core 40 includes a top surface 41, a pair of first side surfaces 42, a pair of second side surfaces 43, and a bottom surface 45. The top surface 41, the first side surfaces 42, the second side surfaces 43, and the bottom surface 45 each have a flat shape. The top surface 41 has a rectangular shape. The pair of first side surfaces 42 are connected to regions corresponding to a set of opposing sides of this rectangle, and are inclined with respect to the top surface 41. The pair of second side surfaces 43 are connected to regions corresponding to the other set of opposing sides of this rectangle, and are inclined with respect to the top surface 41. The first side surfaces 42 and the second side surfaces 43 are arranged to connect between the top surface 41 and the bottom surface 45.

The engagement portion 11A includes a top surface 11B, a pair of first side surfaces 11C, and a pair of second side surfaces 11D. The top surface 11B, the first side surfaces 11C, and the second side surfaces 11D each have a flat shape. The top surface 11B has a rectangular shape. The pair of first side surfaces 11C are connected to regions corresponding to a set of opposing sides of this rectangle, and are inclined with respect to the top surface 11B. The pair of second side surfaces 11D are connected to regions corresponding to the other set of opposing sides of this rectangle, and are inclined with respect to the top surface 11B.

The top surface 41 of the core 40 is along the top surface 11B of the engagement portion 11A. The pair of first side surfaces 42 of the core 40 are along the pair of first side surfaces 11C of the engagement portion 11A. The second side surfaces 43 of the core 40 are along the pair of second side surfaces 11D of the engagement portion 11A. That is, the core 40 has a shape corresponding to the outer shape of the engagement portion 11A.

The plurality of support members 60, 70 include a first support member 60. The first support member 60 has a bar shape that extends from a first end 61, which is the one end, to a second end 62. The first support member 60 is exposed from a surface of the matrix portion 10 at the first end 61. The first support member 60 is in contact with the core 40 at the second end 62. In the present embodiment, a region including the first end 61 protrudes from the surface of the matrix portion 10. The first support member 60 contacts the top surface 41, a first side surface 42, or a second side surface 43 of the core 40 at the second end 62, and extends in a direction perpendicular to the top surface 41, the first side surface 42, or the second side surface 43 of the core 40. The top surface 41, the first side surfaces 42, and the second side surfaces 43 of the core 40 are all in contact with the second end 62 of at least one first support member 60.

The plurality of support members 60, 70 include a second support member 70. The second support member 70 has a bar shape that includes a third end 71, which is the one end, and a fourth end 72, which is an opposite end to the third end 71. The second support member 70 is exposed from the surface of the matrix portion 10 at the third end 71. The second support member 70 is in contact with the core 40 at a side surface 73 located between the third end 71 and the fourth end 72. In the present embodiment, a region including the third end 71 protrudes from the surface of the matrix portion 10. While the fourth end 72 is located within the matrix portion 10 in the present embodiment, the second support member 70 may penetrate through the matrix portion 10 and may be exposed from the surface of the matrix portion 10 at the fourth end 72. The second support member 70 contacts the bottom surface 45 of the core 40 at the side surface 73, and extends in a direction parallel to the bottom surface 45. The bottom surface 45 of the core 40 is in contact with the side surface 73 of at least one (here, more than one) second support member 70.

In the present embodiment, the plurality of support members 60, 70 each have at least one end (first end 61, third end 71) exposed from the surface of the matrix portion 10, and extend toward the interior of the matrix portion 10. The plurality of support members 60, 70 each contact the core 40 at a portion other than the one end (first end 61, third end 71) to thereby define the position of the core 40 within the matrix portion 10. The support members 60, 70 may be made of metal. The metal constituting the support members 60, 70 preferably has a hardness that is equivalent to or higher than that of the metal constituting the matrix portion 10. For example, high hardness steel, such as steel having the component composition of tool steel, bearing steel, spring steel, heat resistant steel, stainless steel, and piano wire as specified in JIS standard, as well as cast iron higher in carbon content can be adopted as the metal constituting the support members 60, 70. From the standpoint of improvement in wear resistance, the support members 60, 70 preferably have a hardness higher than that of the matrix portion 10. However, from the standpoint of defining the position of the core 40, it is sufficient that the support members 60, 70 have a strength capable of holding the core 40 in a desired position. The support members 60, 70 may be composed of mild steel, for example.

In the track chain member 1 in the present embodiment, the core 40 having a hardness higher than that of the matrix portion 10 is embedded in the matrix portion 10. The plurality of support members 60, 70 define the position of the core 40 within the matrix portion 10. With the hard core 40 being thus held in an appropriate position within the matrix portion 10 by the plurality of support members 60, 70, the track chain member 1 has excellent wear resistance. Further, the regions including the one ends of the support members 60, 70 of the present embodiment protrude from the surface of the matrix portion 10. Therefore, in the case of producing the track chain member 1 by casting, the support members 60, 70 can be secured against a mold by having the one ends of the support members 60, 70 brought into contact with, or pierced into, a wall surface defining the mold cavity, and then the core 40 can be supported by the support members 60, 70. Thereafter, the metal constituting the matrix portion 10 is poured in a molten state, so that the core 40 can be readily positioned in an appropriate position. Thus, the wear resistant component according to the present disclosure can provide a wear resistant component with improved wear resistance.

The track chain member 1 of Embodiment 1 can be produced, for example, in the following manner. First, the third end 71 of the second support member 70 is brought into contact with, or pierced into, a wall surface defining a mold cavity, to secure the second support member 70 against the mold. Next, the core 40 is placed on the second support member 70. Subsequently, the first end 61 of the first support member 60 is brought into contact with, or pierced into, the wall surface defining the mold cavity, to make the second end 62 contact the core 40. The above allows the core 40 to be placed in an appropriate position in the mold cavity. The metal constituting the matrix portion 10 is then poured in a molten state.

### Embodiment 2

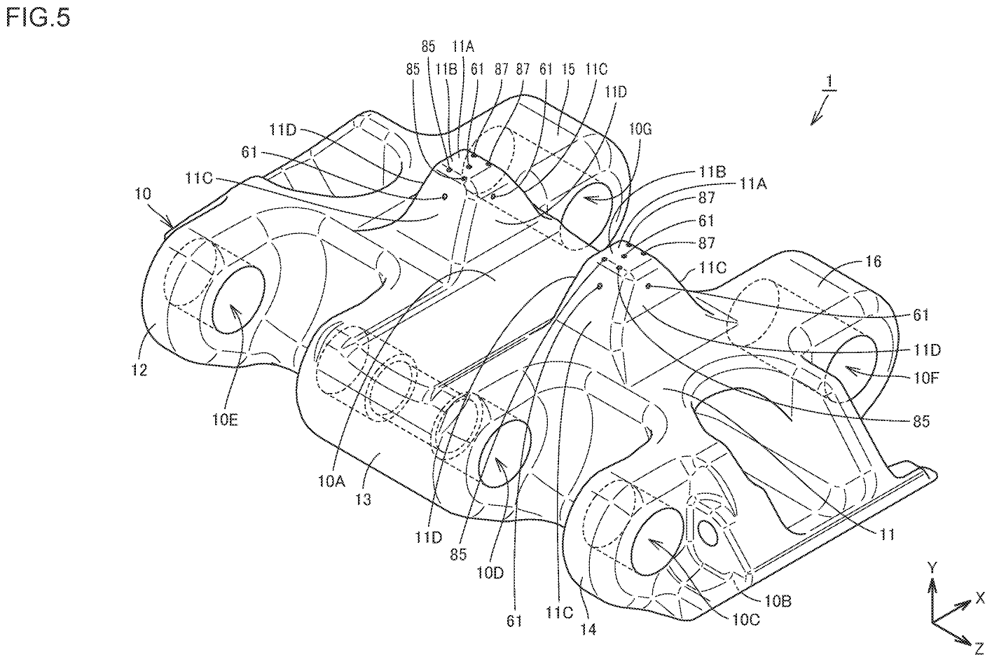

Another embodiment, Embodiment 2, will now be described with reference to FIGS. 5 to 8. The track chain member 1 as the wear resistant component of Embodiment 2 basically has a similar structure, provides similar effects, and can be produced in a similar manner as in the case of Embodiment 1. However, the track chain member 1 of Embodiment 2 differs from that of Embodiment 1 in that it includes a third support member 80 instead of the second support member 70 described above. The parts different from Embodiment 1 will now be described.

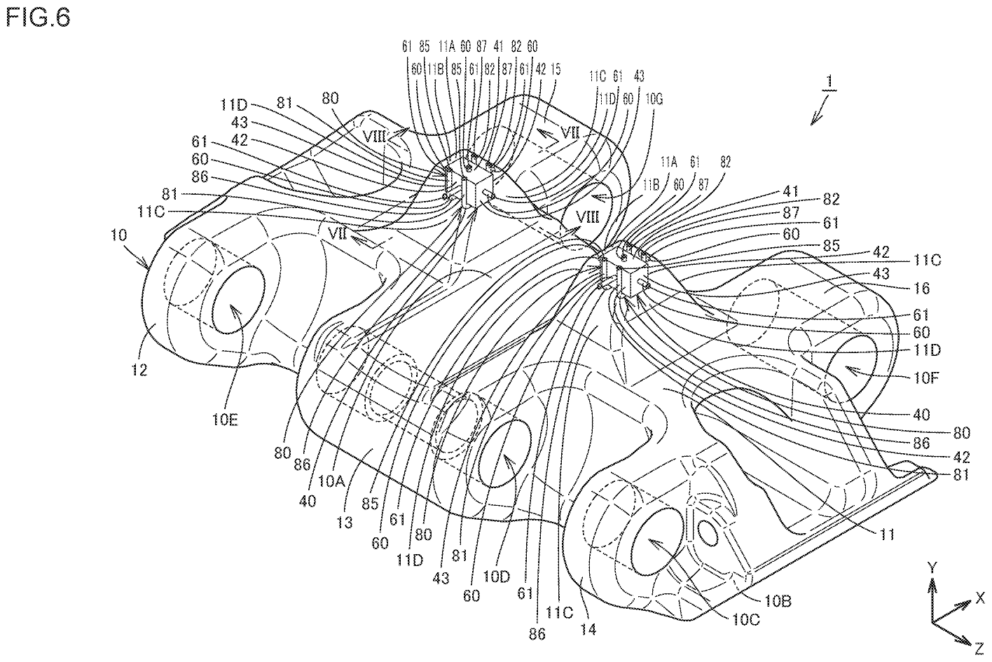

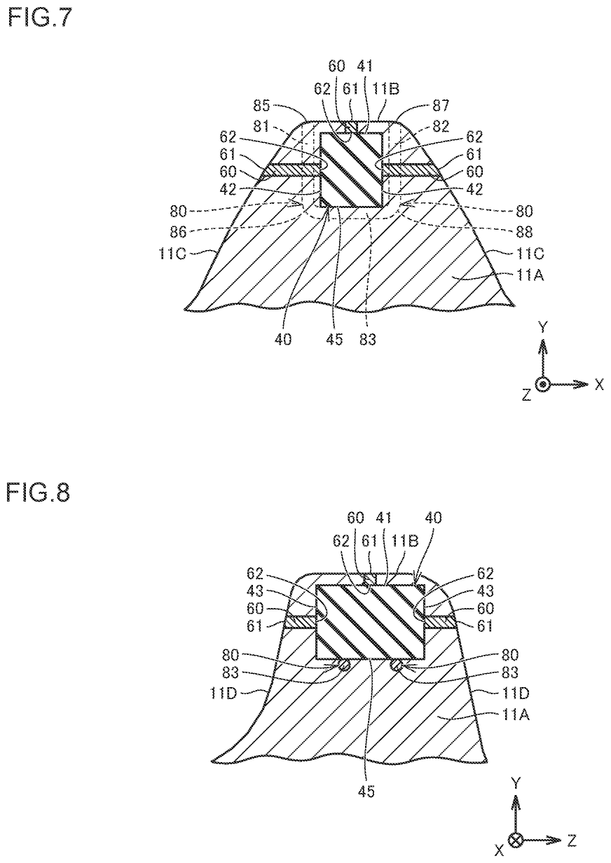

FIG. 5 is a schematic perspective view of the outline of the track chain member in Embodiment 2. FIG. 6 is a schematic perspective view showing the internal structure of the track chain member in Embodiment 2. FIG. 6 corresponds to the state of seeing through the interior of the track chain member in FIG. 5. FIGS. 7 and 8 are schematic cross-sectional views showing the internal structure of a projecting portion of the track chain member in Embodiment 2. In FIGS. 5 to 8, the X axis direction corresponds to the rotational direction of a track that is formed with the track chain members connected in series. In FIGS. 5 to 8, the Y axis direction corresponds to the thickness direction of the track chain member. In FIGS. 5 to 8, the Z axis direction corresponds to the width direction of the track chain member. FIG. 7 is a cross-sectional view in the X-Y plane. FIG. 7 is a cross-sectional view along the line VII-VII in FIG. 6. FIG. 8 is a cross-sectional view in the Y-Z plane. FIG. 8 is a cross-sectional view along the line VIII-VIII in FIG. 6.

Referring to FIGS. 5 to 8, the plurality of support members 60, 80 include a third support member 80. Referring to FIG. 7, the third support member 80 includes a first portion 81, a second portion 82, and a third portion 83. The first portion 81 has a bar shape including a fifth end 85, which is the one end exposed from the matrix portion 10, and a sixth end 86 located within the matrix portion 10. The second portion 82 has a bar shape including a seventh end 87, which is the one end exposed from the matrix portion 10, and an eighth end 88 located within the matrix portion 10. The third portion 83 has a bar shape connecting the sixth end 86 to the eighth end 88. The third support member 80 is in contact with the core 40 at the third portion 83. The first portion 81 and the second portion 82 are parallel. The third portion 83 is orthogonal to the first portion 81 and the second portion 82. In the present embodiment, a region including the fifth end 85 and a region including the seventh end 87 are exposed from the top surface 11, which is the surface of the matrix portion 10. The third support member 80 is in contact with the bottom surface 45 of the core 40 at a side surface of the third portion 83. The core 40 is placed on the third portion 83 of the third support member 80. The third support member 80 has a U shape. The third support member 80 may be composed of a similar material as the first support member 60 and the second support member 70 described above. The third support member 80 is capable of performing similar functions as the second support member in Embodiment 1. Therefore, the track chain member 1 of Embodiment 2 provides similar effects as in Embodiment 1. In the present embodiment, the first portion 81 and the second portion 82 of the third support member 80 are not in contact with the core 40. However, at least one of the first portion 81 and the second portion 82 may be in contact with the core 40.

### Embodiment 3

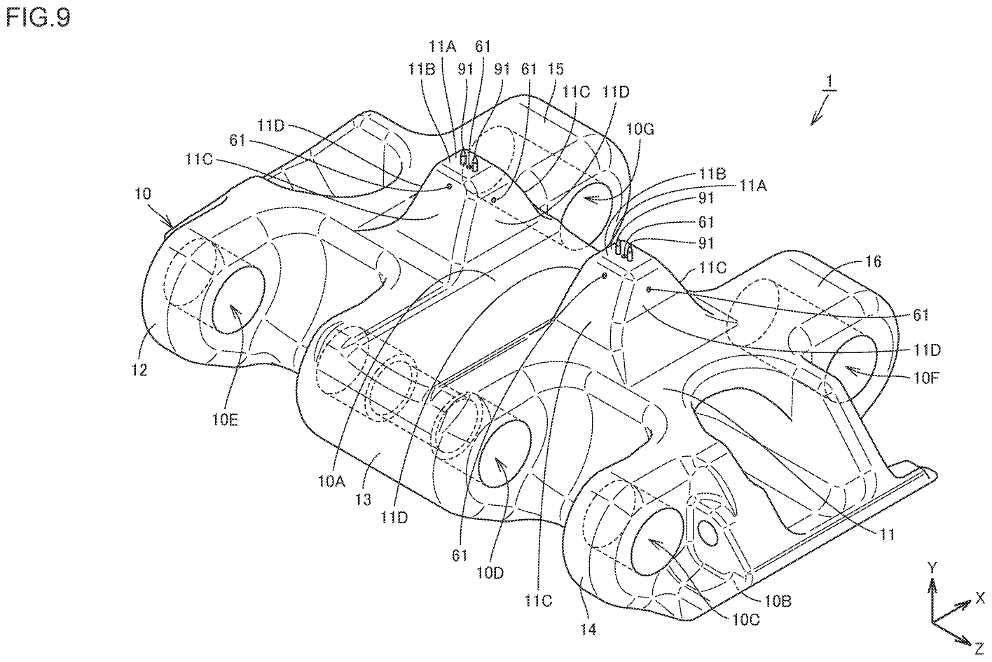

Yet another embodiment, Embodiment 3, will now be described with reference to FIGS. 9 to 13. The track chain member 1 as the wear resistant component of Embodiment 3 basically has a similar structure, provides similar effects, and can be produced in a similar manner as in the case of Embodiment 1. However, the track chain member 1 of Embodiment 3 differs from that of Embodiment 1 in that it includes a fourth support member 90 instead of the second support member 70 described above. The parts different from Embodiment 1 will now be described.

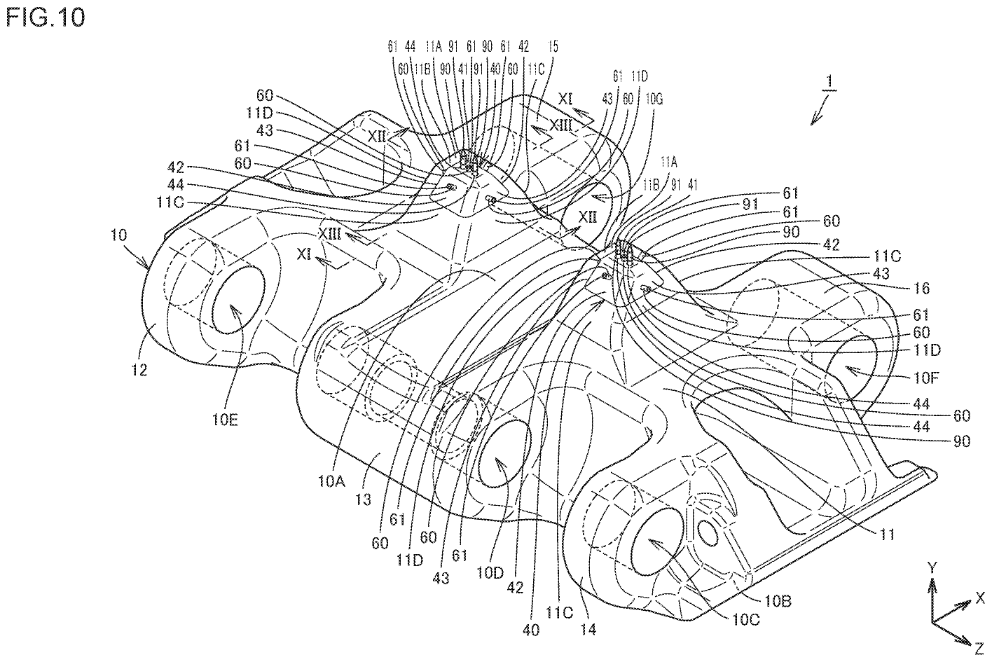

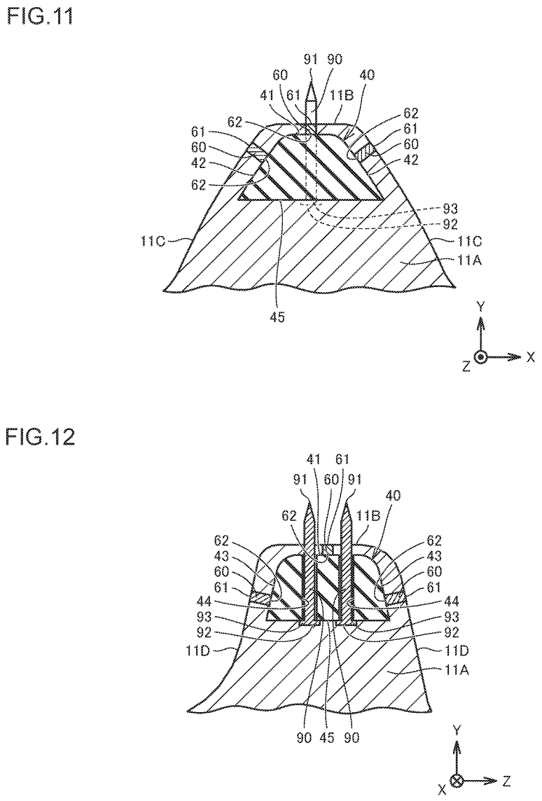

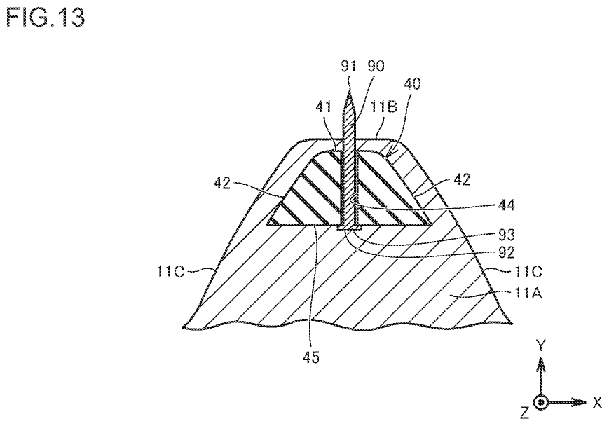

FIG. 9 is a schematic perspective view of the outline of the track chain member in Embodiment 3. FIG. 10 is a schematic perspective view showing the internal structure of the track chain member in Embodiment 3. FIG. 10 corresponds to the state of seeing through the interior of the track chain member in FIG. 9. FIGS. 11, 12, and 13 are schematic cross-sectional views showing the internal structure of a projecting portion of the track chain member in Embodiment 3. In FIGS. 9 to 13, the X, Y, and Z axis directions mean the same directions as in Embodiments 1 and 2 above. FIGS. 11 and 13 are cross-sectional views in the X-Y plane. FIG. 12 is a cross-sectional view in the Y-Z plane. FIG. 11 is a cross-sectional view along the line XI-XI in FIG. 10. FIG. 12 is a cross-sectional view along the line XII-XII in FIG. 10. FIG. 13 is a cross-sectional view along the line XIII-XIII in FIG. 10.

Referring to FIGS. 9 to 13, the plurality of support members 60, 90 include a fourth support member 90. The fourth support member 90 has a bar shape including a ninth end 91, which is the one end exposed from the matrix portion 10, and a tenth end 92 located within the matrix portion 10. A region including the tenth end 92 is a flange 93 that has a larger cross-sectional area perpendicular to the longitudinal direction than an adjacent region. The core 40 has a straight through hole 44 formed to penetrate from the top surface 41 to the bottom surface 45. The fourth support member 90 penetrates the core 40 through the through hole 44. The fourth support member 90 is in contact with the core 40 at the flange 93. A plurality of (here, two) through holes 44 are formed side by side in the Z axis direction. A plurality of (here, two) fourth support members 90 are arranged corresponding to the through holes 44.

The fourth support member 90 has a cross-sectional area perpendicular to the longitudinal direction that decreases near the ninth end 91 with increasing proximity to the ninth end 91. The fourth support member 90 is pointed in a region including the ninth end 91. This facilitates piercing the ninth end 91 of the fourth support member 90 into a wall surface defining the mold cavity. The fourth support member 90 may be composed of a similar material as the first support member 60 and the second support member 70 described above. The fourth support member 90 is capable of performing similar functions as the second support member in Embodiment 1. Therefore, the track chain member 1 of Embodiment 3 provides similar effects as in Embodiment 1.

### Embodiment 4

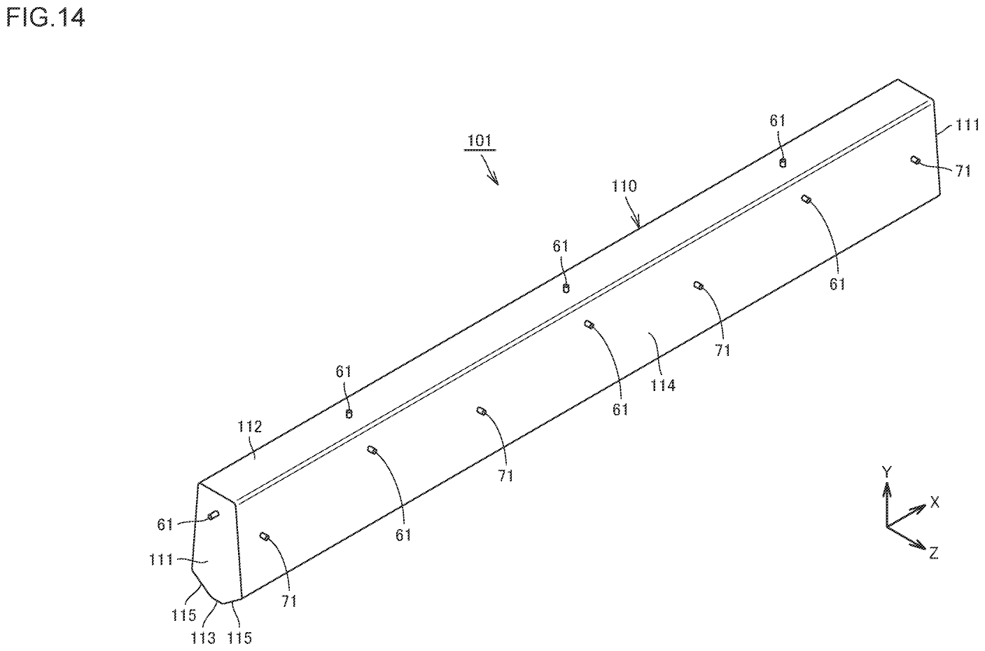

Referring now to FIGS. 14 to 17, an example of applying the present invention to a lug bar will be described as Embodiment 4. The lug bar as the wear resistant component of Embodiment 4 has a structure with a similar configuration to that of the track chain member of Embodiment 1 applied to the lug bar.

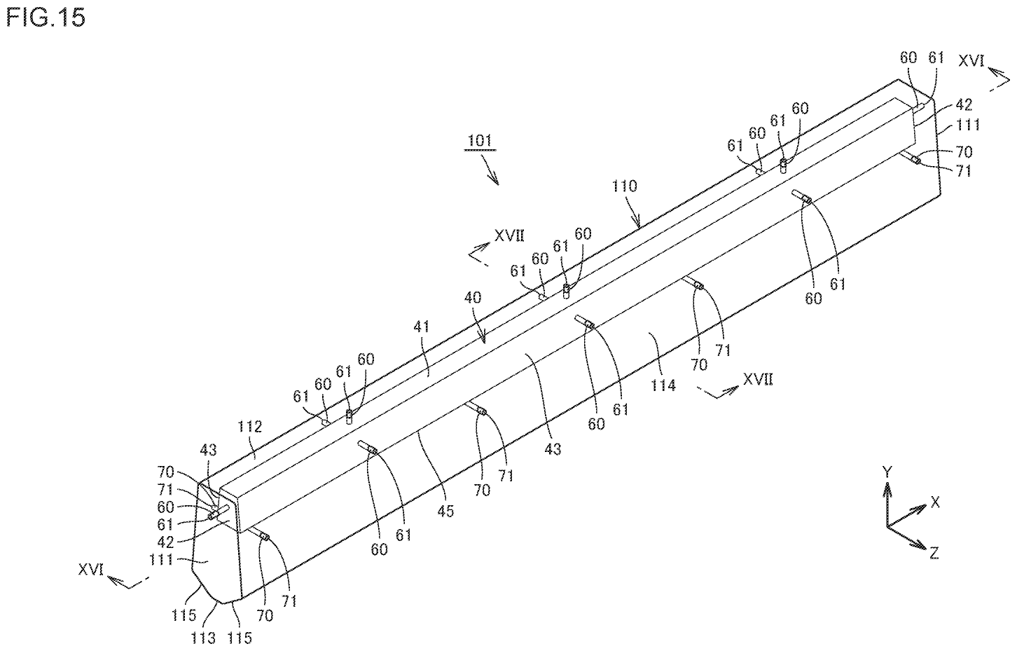

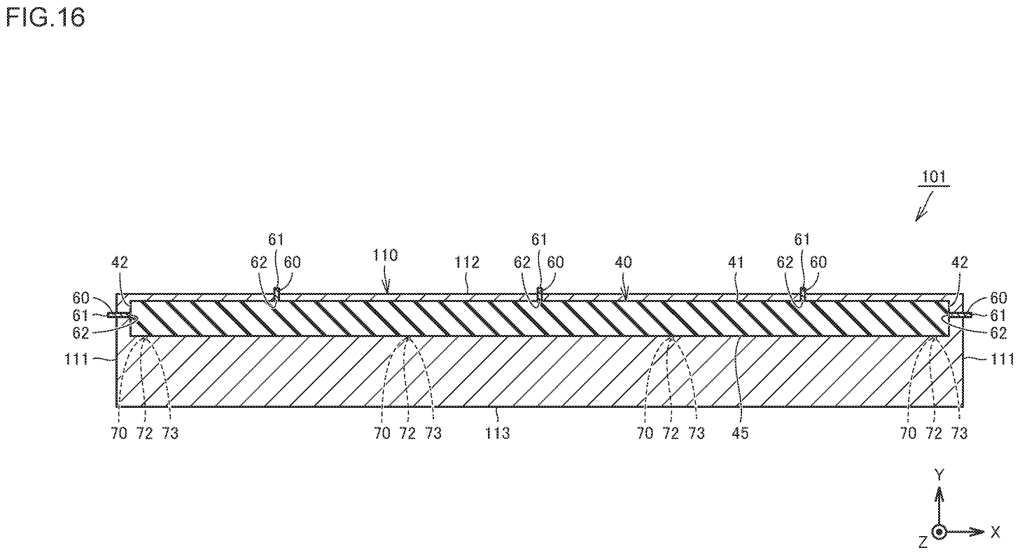

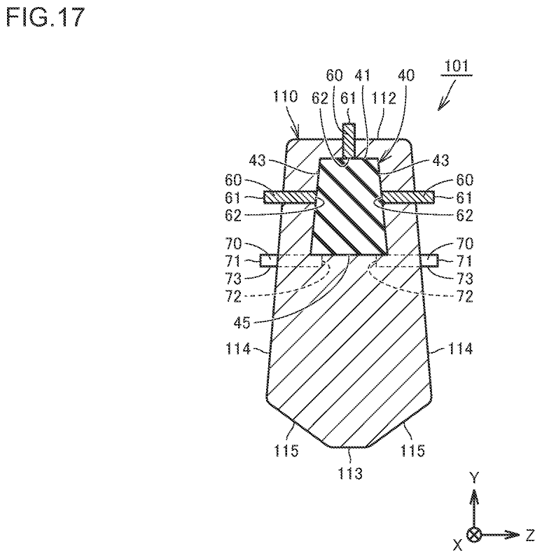

FIG. 14 is a schematic perspective view of the outline of the lug bar in Embodiment 4. FIG. 15 is a schematic perspective view showing the internal structure of the lug bar in Embodiment 4. FIG. 15 corresponds to the state of seeing through the interior of the lug bar in FIG. 14. FIGS. 16 and 17 are schematic cross-sectional views showing the internal structure of the lug bar in Embodiment 4. In FIGS. 14 to 17, the X axis direction corresponds to the longitudinal direction of the lug bar. In FIGS. 14 to 17, the Y axis direction corresponds to the height direction of the lug bar. In FIGS. 14 to 17, the Z axis direction corresponds to the width direction of the lug bar. FIG. 16 is a cross-sectional view in the X-Y plane. FIG. 16 is a cross-sectional view along the line XVI-XVI in FIG. 15. FIG. 17 is a cross-sectional view in the Y-Z plane. FIG. 17 is a cross-sectional view along the line XVII-XVII in FIG. 15.

Referring to FIGS. 14 and 15, the lug bar 101 in Embodiment 4 is used, when a grouser portion of a shoe constituting a track wears out, for repairing the shoe, with the lug bar being joined to the grouser portion. The lug bar 101 has a bar shape that extends along the X axis direction. The lug bar 101 has a pair of end surfaces 111 of a hexagonal shape, and an outer peripheral surface connecting the pair of end surfaces 111. The outer peripheral surface includes a joint surface 113, a pair of first side surfaces 115, a pair of second side surfaces 114, and a tip end surface 112.

The joint surface 113, the first side surfaces 115, the second side surfaces 114, and the tip end surface 112 each have a rectangular shape. The joint surface 113, the first side surfaces 115, the second side surfaces 114, and the tip end surface 112 are each orthogonal to the pair of end surfaces 111. The lug bar 101 has a hexagonal column shape.

The joint surface 113 is a surface to be joined to the grouser portion at the time of repairing a shoe. The first side surfaces 115 are located on both sides of the joint surface 113 in the circumferential direction of the lug bar 101. The second side surfaces 114 are located on sides of the first side surfaces 115 opposite to the joint surface 113 in the circumferential direction of the lug bar 101. The tip end surface 112 is arranged to connect the pair of second side surfaces 114.

Referring to FIGS. 15 to 17, the lug bar 101 includes a matrix portion 110, a core 40, and a plurality of support members 60, 70. The matrix portion 110 is made of a similar metal as in Embodiment 1. The core 40 is embedded in the matrix portion 110. The core 40 has a hardness higher than that of the matrix portion 110. The core 40 is made of a similar material as in Embodiment 1.

The core 40 includes a top surface 41, a pair of first side surfaces 42 (end surfaces), a pair of second side surfaces 43, and a bottom surface 45. The top surface 41, the first side surfaces 42, the second side surfaces 43, and the bottom surface 45 each have a flat shape. The top surface 41 has a rectangular shape. The pair of first side surfaces 42 are connected to regions corresponding to a set of opposing sides of this rectangle, and are inclined with respect to (orthogonal to) the top surface 41. The pair of second side surfaces 43 are connected to regions corresponding to the other set of opposing sides of this rectangle, and are inclined with respect to the top surface 41. The first side surfaces 42 and the second side surfaces 43 are arranged to connect between the top surface 41 and the bottom surface 45.

The top surface 41 of the core 40 is along the tip end surface 112 of the lug bar 101. The pair of first side surfaces 42 (end surfaces) of the core 40 are along the pair of end surfaces 111 of the lug bar 101. The pair of second side surfaces 43 of the core 40 are along the pair of second side surfaces 114 of the lug bar 101. That is, the core 40 has a shape that corresponds to a portion of the outer shape of the lug bar 101.

The plurality of support members 60, 70 include a first support member 60. The first support member 60 has a similar shape as in Embodiment 1. The first support member 60 is exposed from a surface of the matrix portion 110 at a first end 61. The first support member 60 is in contact with the core 40 at a second end 62. In the present embodiment, a region including the first end 61 protrudes from a surface of the matrix portion 110. The first support member 60 is in contact with the top surface 41, a first side surface 42, or a second side surface 43 of the core 40 at the second end 62, and extends toward the tip end surface 112, an end surface 111, or a second side surface 114 of the lug bar 101. The top surface 41, the first side surfaces 42, and the second side surfaces 43 of the core 40 are all in contact with the second end 62 of at least one first support member 60.

The plurality of support members 60, 70 include a second support member 70. The second support member 70 has a similar shape as in Embodiment 1. The second support member 70 is exposed from the surface of the matrix portion 110 at a third end 71. The second support member 70 is in contact with the core 40 at a side surface 73 located between the third end 71 and a fourth end 72. In the present embodiment, a region including the third end 71 protrudes from the surface of the matrix portion 110. Although the fourth end 72 is located within the matrix portion 110 in the present embodiment, the second support member 70 may penetrate through the matrix portion 110 and have the fourth end 72 exposed from the surface of the matrix portion 110. The second support member 70 contacts the bottom surface 45 of the core 40 at the side surface 73, and extends in a direction parallel to the bottom surface 45. The bottom surface 45 of the core 40 is in contact with the side surfaces 73 of a plurality of (here, eight) second support members 70.

In the present embodiment, as in Embodiment 1, the plurality of support members 60, 70 define the position of the core 40 within the matrix portion 10. As a result, the lug bar 101 in the present embodiment is a wear resistant component with improved wear resistance, as is the track chain member 1 of Embodiment 1. The lug bar 101 in the present embodiment can be produced using a procedure similar to that used for the track chain member 1 of Embodiment 1.

### Embodiment 5

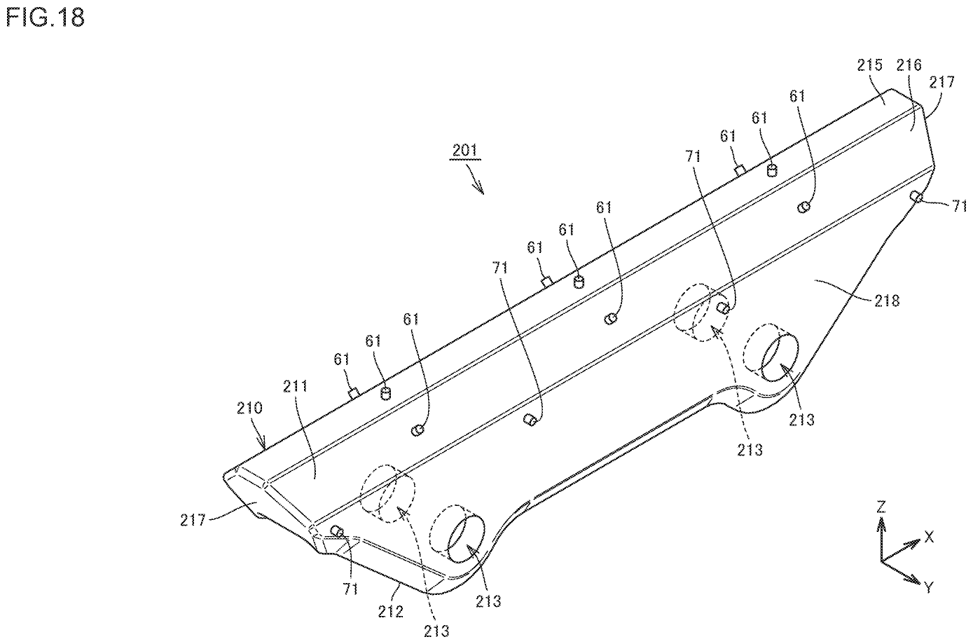

Referring now to FIGS. 18 to 21, an example of applying the present invention to a side protector will be described as Embodiment 5. The side protector as the wear resistant component of Embodiment 5 has a structure with a similar configuration to that of the track chain member of Embodiment 1 applied to the side protector.

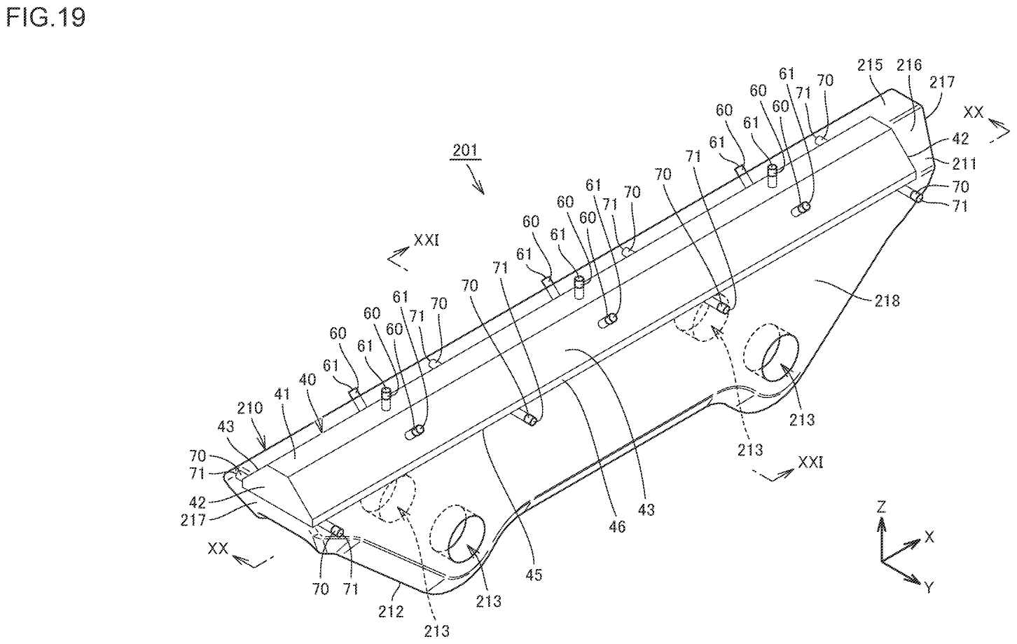

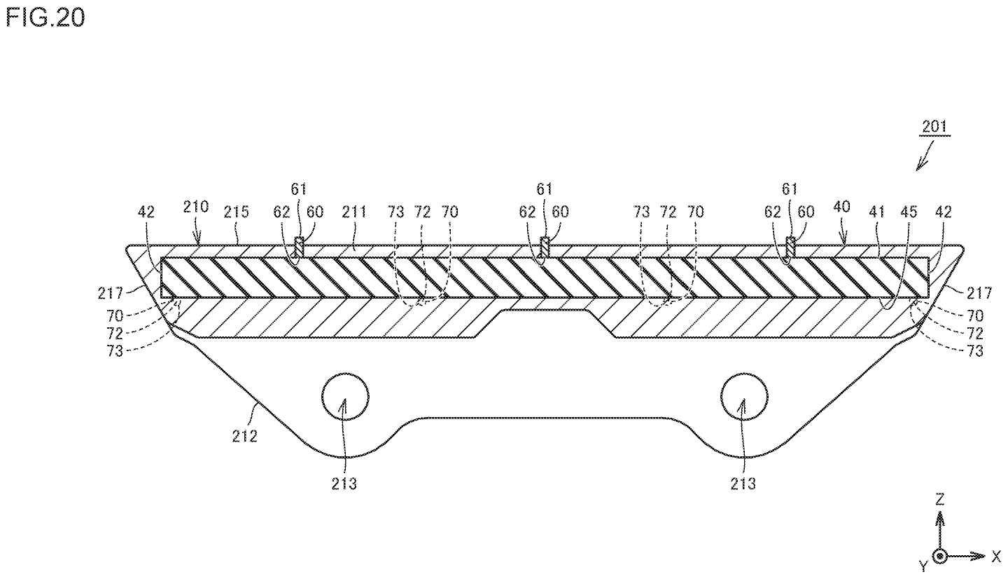

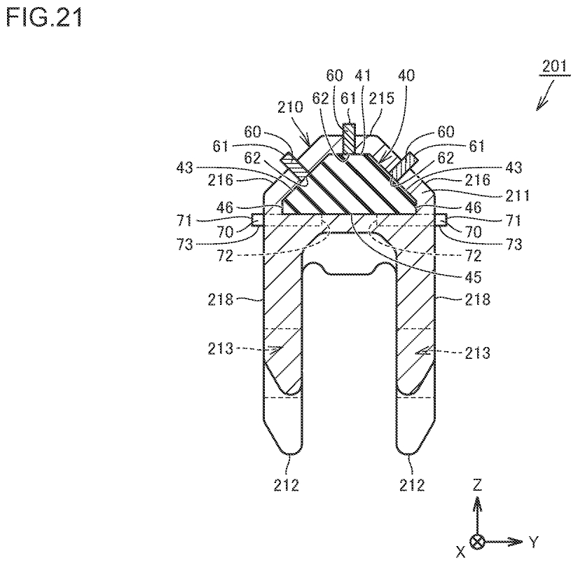

FIG. 18 is a schematic perspective view of the outline of the side protector in Embodiment 5. FIG. 19 is a schematic perspective view showing the internal structure of the side protector in Embodiment 5. FIG. 19 corresponds to the state of seeing through the interior of the side protector in FIG. 18. FIGS. 20 and 21 are schematic cross-sectional views showing the internal structure of the side protector in Embodiment 5. In FIGS. 18 to 21, the X axis direction corresponds to the longitudinal direction of the side protector. In FIGS. 18 to 21, the Y axis direction corresponds to the width direction of the side protector. In FIGS. 18 to 21, the Z axis direction corresponds to the height direction of the side protector. FIG. 20 is a cross-sectional view in the X-Z plane. FIG. 20 is a cross-sectional view along the line XX-XX in FIG. 19. FIG. 21 is a cross-sectional view in the Y-Z plane. FIG. 21 is a cross-sectional view along the line XXI-XXI in FIG. 19.

Referring to FIGS. 18 and 19, the side protector 201 in Embodiment 5 includes a body portion 211 and a pair of leg portions 212 connected to the body portion 211. The body portion 211 has a bar shape extending along the X axis direction (a first direction). The pair of leg portions 212 are connected to both ends in the width direction (Y direction as a second direction) of the body portion 211. The leg portions 212 are arranged to rise along the Z axis direction (a third direction) from the body portion 211. The leg portions 212 each have a plate shape extending along the X-Z plane. The pair of leg portions 212 are arranged parallel to each other. The pair of leg portions 212 each have a pair of through holes 213 formed, apart from each other in the X axis direction, to penetrate through the leg portion 212 in the thickness direction. The pair of leg portions 212 have their through holes 213 arranged in the same position in the X axis direction. The side protector 201 is a wear resistant component that is attached, for example, to an outer edge surrounding the opening of a bucket (not shown) of a hydraulic excavator, to suppress the wear of the outer edge. The side protector 201 is secured to the bucket, in the state where a plate-shaped portion constituting the outer edge of the bucket opening is inserted between the pair of leg portions 212, as fixing members such as pins are inserted into the respective through holes 213.

A matrix portion 210 constituting the surface of the side protector 201 in Embodiment 5 includes a pair of end surfaces 217, which are flat surfaces constituting the ends in the longitudinal direction (X axis direction) of the body portion 211. The matrix portion 210 further includes a top surface 215, which is a flat surface extending in the X axis direction and connecting the pair of end surfaces 217, a pair of inclined surfaces 216, which are flat surfaces connected to both ends in the width direction (Y direction) of the top surface 215 and inclined with respect to the top surface 215, and a pair of side surfaces 218, which are flat surfaces connected to sides of the pair of inclined surfaces 216 opposite to the top surface 215 and inclined with respect to the inclined surfaces 216. The top surface 215 is a surface along the X-Y plane. The side surfaces 218 are surfaces along the X-Z plane. In other words, the plane including the top surface 215 and the plane including a side surface 218 are orthogonal.

Referring to FIGS. 19 to 21, the side protector 201 includes the matrix portion 210, a core 40, and a plurality of support members 60, 70. The matrix portion 210 is made of a similar metal as in Embodiment 1. The core 40 is embedded in a region in the matrix portion 210 corresponding to the body portion 211. The core 40 has a hardness higher than that of the matrix portion 210. The core 40 is made of a similar material as in Embodiment 1.

The core 40 includes a top surface 41, a pair of first side surfaces 42 (end surfaces), a pair of second side surfaces 43, and a bottom surface 45. The top surface 41, the first side surfaces 42, the second side surfaces 43, and the bottom surface 45 each have a flat shape. The top surface 41 has a rectangular shape. The pair of first side surfaces 42 are connected to regions corresponding to a set of opposing sides of this rectangle, and are inclined with respect to (orthogonal to) the top surface 41. The pair of second side surfaces 43 are connected to regions corresponding to the other set of opposing sides of this rectangle, and are inclined with respect to the top surface 41. The first side surfaces 42 and the second side surfaces 43 are arranged to connect between the top surface 41 and the bottom surface 45.

The top surface 41 of the core 40 is along the top surface 215 of the matrix portion 210. The pair of second side surfaces 43 of the core 40 are along the pair of inclined surfaces 216 of the matrix portion 210. That is, the core 40 has a shape that corresponds to a portion of the outer shape of the body portion 211 of the side protector 201.

The plurality of support members 60, 70 include a first support member 60. The first support member 60 has a similar shape as in Embodiment 1. The first support member 60 is exposed from a surface of the matrix portion 210 at a first end 61. The first support member 60 is in contact with the core 40 at a second end 62. In the present embodiment, a region including the first end 61 protrudes from the surface of the matrix portion 210. The first support member 60 contacts the top surface 41 or a second side surface 43 of the core 40 at the second end 62, and extends toward the top surface 215 or an inclined surface 216 of the matrix portion 210. The top surface 41 and the second side surfaces 43 of the core 40 are in contact with the second end 62 of at least one (here, more than one) first support member 60.

The plurality of support members 60, 70 include a second support member 70. The second support member 70 has a similar shape as in Embodiment 1. The second support member 70 is exposed from the surface of the matrix portion 210 at a third end 71. The second support member 70 is in contact with the core 40 at a side surface 73 located between the third end 71 and a fourth end 72. In the present embodiment, a region including the third end 71 protrudes from the surface of the matrix portion 210. Although the fourth end 72 is located within the matrix portion 210 in the present embodiment, the second support member 70 may penetrate through the matrix portion 210 and have its fourth end 72 exposed from the surface of the matrix portion 210. The second support member 70 contacts the bottom surface 45 of the core 40 at the side surface 73, and extends in a direction parallel to the bottom surface 45. The bottom surface 45 of the core 40 is in contact with side surfaces 73 of a plurality of (here, eight) second support members 70.

In the present embodiment, as in Embodiment 1, the plurality of support members 60, 70 define the position of the core 40 within the matrix portion 210. As a result, the side protector 201 in the present embodiment is a wear resistant component with improved wear resistance, as is the track chain member 1 of Embodiment 1. The side protector 201 in the present embodiment can be produced using a procedure similar to that used for the track chain member 1 of Embodiment 1.

### Embodiment 6

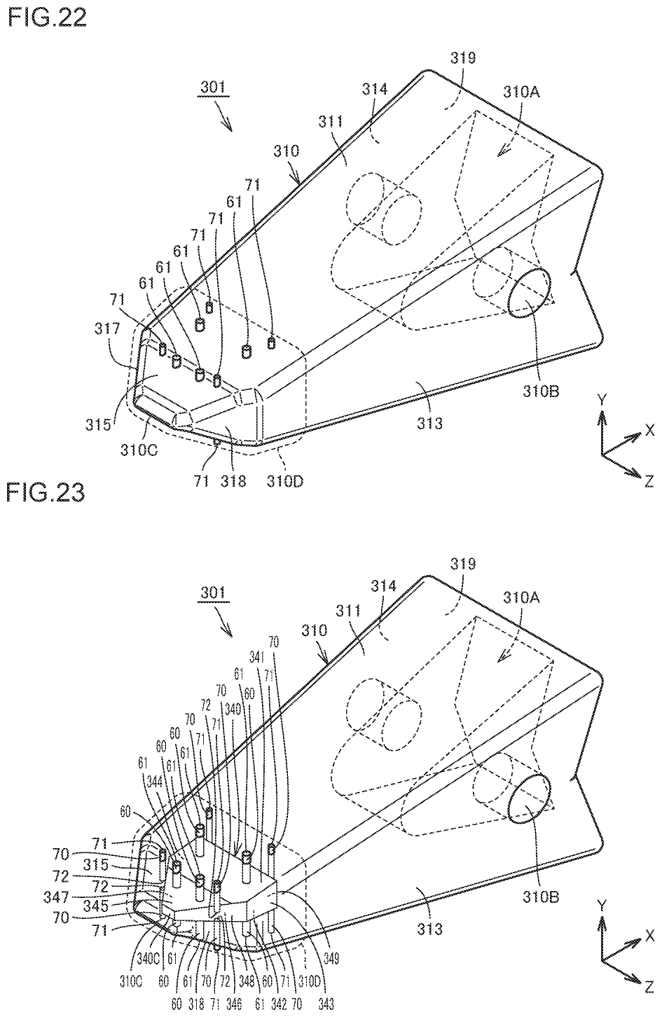

Referring now to FIGS. 22 to 24, an example of applying the present invention to a tooth will be described as Embodiment 6. The tooth as the wear resistant component of Embodiment 6 has a structure with a similar configuration to that of the track chain member of Embodiment 1 applied to the tooth.

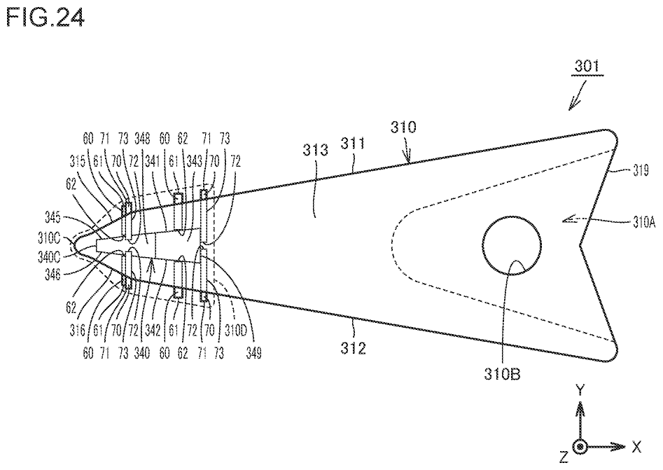

FIG. 22 is a schematic perspective view of the outline of the tooth in Embodiment 6. FIG. 23 is a schematic perspective view showing the internal structure of the tooth in Embodiment 6. FIG. 23 corresponds to the state of seeing through the interior of the tooth in FIG. 22. FIG. 24 is a schematic plan view showing the internal structure of the tooth in Embodiment 6. In FIGS. 22 to 24, the X axis direction corresponds to the longitudinal direction of the tooth. In FIGS. 22 to 24, the Y axis direction corresponds to the thickness direction of the tooth. In FIGS. 22 to 24, the Z axis direction corresponds to the width direction of the tooth.

Referring to FIGS. 22 to 24, a matrix portion 310 constituting the surface of the tooth 301 in Embodiment 6 includes a tip end 310C and a proximal end 319. The matrix portion 310 includes a first surface 311, a second surface 312, a third surface 313, a fourth surface 314, a fifth surface 315, a sixth surface 316, a seventh surface 317, and an eighth surface 318.

The first surface 311 and the second surface 312 are each connected to the proximal end 319. The first surface 311 and the second surface 312 are arranged apart from each other in the Y axis direction such that their distance decreases with increasing proximity to the tip end 310C. The fifth surface 315 and the sixth surface 316 connect the first surface 311 and the second surface 312, respectively, to the tip end 310C. The fifth surface 315 and the sixth surface 316 are arranged such that their distance decreases with increasing proximity to the tip end 310C. In the X-Y plane, the angle made by the fifth surface 315 and the sixth surface 316 is greater than the angle made by the first surface 311 and the second surface 312.

The third surface 313 and the fourth surface 314 are each connected to the proximal end 319. The third surface 313 and the fourth surface 314 are arranged apart from each other in the Z axis direction such that their distance decreases with increasing proximity to the tip end 310C. The seventh surface 317 and the eighth surface 318 connect the fourth surface 314 and the third surface 313, respectively, to the tip end 310C. The seventh surface 317 and the eighth surface 318 are arranged such that their distance decreases with increasing proximity to the tip end 310C. In the X-Z plane, the angle made by the seventh surface 317 and the eighth surface 318 is greater than the angle made by the third surface 313 and the fourth surface 314. The tip end 310C is a surface (region) extending in the Z axis direction.

The proximal end 319 has a concave portion 310A formed toward the tip end 310C (recessed in the X axis direction). The matrix portion 310 has a through hole 310B formed to penetrate from the third surface 313 to the fourth surface 314. The through hole 310B intersects the concave portion 310A. That is, the through hole 310B is in communication with the concave portion 310A.

The tooth 301 is attached, for example, to a bucket (not shown) of a hydraulic excavator. More specifically, a tooth adapter (not shown) is attached to an outer edge of the bucket opening of the hydraulic excavator. The tooth adaptor has its tip end inserted into the concave portion 310A formed in the proximal end 319 of the tooth 301 (matrix portion 310). In the through hole 310B, a pin (not shown) is inserted to penetrate through the through hole 310B. The tooth 301 is thus attached to the bucket via the tooth adaptor.

The tooth 301 includes the matrix portion 310, a core 340, and a plurality of support members 60, 70. The matrix portion 310 is made of a similar metal as in Embodiment 1. The core 340 is embedded in a region in the matrix portion 310 corresponding to a tip end region 310D thereof. The core 340 has a hardness higher than that of the matrix portion 310. The core 340 is made of a similar material as in Embodiment 1.

The core 340 has a surface (outer shape) that includes a first surface 341, a second surface 342, a third surface 343, a fourth surface 344, a fifth surface 345, a sixth surface 346, a seventh surface 347, an eighth surface 348, a ninth surface 349, and a tip end 340C. The first surface 341 is along the first surface 311 of the matrix portion 310. The second surface 342 is along the second surface 312 of the matrix portion 310. The third surface 343 is along the third surface 313 of the matrix portion 310. The fourth surface 344 is along the fourth surface 314 of the matrix portion 310. The fifth surface 345 is along the fifth surface 315 of the matrix portion 310. The sixth surface 346 is along the sixth surface 316 of the matrix portion 310. The seventh surface 347 is along the seventh surface 317 of the matrix portion 310. The eighth surface 348 is along the eighth surface 318 of the matrix portion 310. The tip end 340C is along the tip end 310C of the matrix portion 310 (tooth 301). The ninth surface 349 is a surface opposite to the tip end 340C in the X axis direction (a surface facing the proximal end 319).

The matrix portion 310 includes the tip end region 310D that tapers toward the tip end 310C. The core 340 is arranged within the tip end region 310D and has a shape corresponding to the outer shape of the tip end region 310D. That is, the core 340 has an outer shape that follows the outer shape of the tip end region 310D. As explained from another perspective, the outer shape of the core 340 corresponds to a substantially similarly reduced shape of the outer shape of the tip end region 310D.

The plurality of support members 60, 70 include a first support member 60. The first support member 60 has a similar shape as in Embodiment 1. The first support member 60 is exposed from a surface of the matrix portion 310 at a first end 61. The first support member 60 is in contact with the core 340 at a second end 62. In the present embodiment, a region including the first end 61 protrudes from the surface of the matrix portion 310. The first support member 60 contacts the first surface 341, the second surface 342, the fifth surface 345, or the sixth surface 346 of the core 340 at the second end 62, and extends toward the first surface 311, the second surface 312, the fifth surface 315, or the sixth surface 316, respectively, of the matrix portion 310. The first surface 341, the second surface 342, the fifth surface 345, and the sixth surface 346 of the core 340 are each in contact with the second end 62 of at least one (here, more than one) first support member 60.

The plurality of support members 60, 70 include a second support member 70. The second support member 70 has a similar shape as in Embodiment 1. The second support member 70 is exposed from the surface of the matrix portion 310 at a third end 71. The second support member 70 is in contact with the core 340 at a side surface 73 located between the third end 71 and a fourth end 72. In the present embodiment, a region including the third end 71 protrudes from the surface of the matrix portion 310. Although the fourth end 72 is located within the matrix portion 310 in the present embodiment, the second support member 70 may penetrate through the matrix portion 310 and have its fourth end 72 exposed from the surface of the matrix portion 310. The second support members 70 contact the seventh surface 347, the eighth surface 348, and the ninth surface 349 of the core 340 at the side surfaces 73, and extend in a direction parallel to these surfaces. The seventh surface 347, the eighth surface 348, and the ninth surface 349 of the core 340 are each in contact with the side surfaces 73 of a plurality of second support members 70.

In the present embodiment, as in Embodiment 1, the plurality of support members 60, 70 define the position of the core 340 within the matrix portion 310. As a result, the tooth 301 in the present embodiment is a wear resistant component with improved wear resistance, as is the track chain member 1 of Embodiment 1. The tooth 301 in the present embodiment can be produced using a procedure similar to that used for the track chain member 1 of Embodiment 1.

While the track chain member, the lug bar, the side protector, and the tooth have been described as examples of the wear resistant component of the present disclosure in Embodiments 1 to 6 above, the wear resistant component of the present disclosure is not limited thereto. The wear resistant component of the present disclosure is applicable to various components that require wear resistance due to the use in applications where they come into contact with earth, sand, soil, and/or rock, for example. The wear resistant component of the present disclosure is particularly suitably applicable to components having the wear problem, such as a tooth adapter, a ripping tip, and a tooth of a concrete crusher, which is an attachment for a hydraulic excavator. The wear resistant component of the present disclosure is also applicable to a corner guard (a component attached to a bottom corner) and a lip shroud (a component attached to a bucket lip), which are components for suppressing progress of local wear of the bucket, likewise the side protector described above. While the application of the wear resistant component of the present disclosure to components of the bucket of a hydraulic excavator has been described above, the wear resistant component of the present disclosure is also applicable similarly to components of a bucket of a wheel loader. Furthermore, while the case where the first support member 60, the second support member 70, the third support member 80, and the fourth support member 90 protrude from the matrix portion at least at one end has been described in Embodiments 1 to 6 above, if it is not appropriate for the support members 60, 70, 80, and 90 to protrude from the matrix portion in consideration of the function of the wear resistant component, the support members 60, 70, 80, and 90 may have their one ends flush with the surface of the matrix portion. In this case, in the production process of the wear resistant component, the support members 60, 70, 80, and 90 may be made to protrude from the matrix portion at the time of casting, and then the one ends of the support members 60, 70, 80, and 90 may be processed to be flush with the surface of the matrix portion in the finishing process or the like.

It should be understood that the embodiments disclosed herein are illustrative and non-restrictive in every respect. The scope of the present invention is defined by the terms of the claims, rather than the description above, and is intended to include any modifications within the scope and meaning equivalent to the terms of the claims.

### REFERENCE SIGNS LIST

1: track chain member; 10: matrix portion; 10A: inner surface; 10B: rail surface; 10C, 10D, 10E, 10F, 10G: through hole; 11: body portion; 11A: engagement portion; 11B: top surface; 11C: first side surface; 11D: second side surface; 12: first protrusion; 13: second protrusion; 14: third protrusion; 15: fourth protrusion; 16: fifth protrusion; 40: core; 41: top surface; 42: first side surface; 43: second side surface; 44: through hole; 45: bottom surface; 60: first support member; 61: first end; 62: second end; 70: second support member; 71: third end; 72: fourth end; 73: side surface; 80: third support member; 81: first portion; 82: second portion; 83: third portion; 85: fifth end; 86: sixth end; 87: seventh end; 88: eighth end; 90: fourth support member; 91: ninth end; 92: tenth end; 93: flange; 101: lug bar; 110: matrix portion; 111: end surface; 112: tip end surface; 113: joint surface; 114: second side surface; 115: first side surface; 201: side protector; 210: matrix portion; 211: body portion; 212: leg portion; 213: through hole; 215: top surface; 216: inclined surface; 217: end surface; 218: side surface; 301: tooth; 310: matrix portion; 310A: recessed portion; 310B: through hole; 310C: tip end; 310D: tip end region; 311: first surface; 312: second surface; 313: third surface; 314: fourth surface; 315: fifth surface; 316: sixth surface; 317: seventh surface; 318: eighth surface; 319: proximal end; 340: core; 340C: tip end; 341: first surface; 342: second surface; 343: third surface; 344: fourth surface; 345: fifth surface; 346: sixth surface; 347: seventh surface; 348: eighth surface; and 349: ninth surface.

1. A wear resistant component comprising:
a matrix portion made of metal;
a core embedded in the matrix portion, the core having a hardness higher than a hardness of the matrix portion; and
a plurality of support members having at least one end exposed from a surface of the matrix portion, extending toward an interior of the matrix portion, and contacting the core at a portion other than the one end to define a position of the core within the matrix portion.

2. The wear resistant component according to claim 1, wherein
the plurality of support members include a first support member,
the first support member
has a bar shape extending from a first end, which is the one end, to a second end, and
is exposed from the surface of the matrix portion at the first end, and contacts the core at the second end.

3. The wear resistant component according to claim 1, wherein
the plurality of support members include a second support member,
the second support member
has a bar shape including a third end, which is the one end, and a fourth end, which is an opposite end to the third end,
is exposed from the surface of the matrix portion at least at the third end, and
contacts the core at a side surface located between the third end and the fourth end.

4. The wear resistant component according to claim 1, wherein
the plurality of support members include a third support member,
the third support member includes
a first portion of a bar shape including a fifth end, which is the one end exposed from the matrix portion, and a sixth end located within the matrix portion,
a second portion of a bar shape including a seventh end exposed from the matrix portion and an eighth end located within the matrix portion, and
a third portion of a bar shape connecting the sixth end to the eighth end, and contacting the core.

5. The wear resistant component according to claim 4, wherein
the first portion and the second portion are parallel, and
the third portion is orthogonal to the first portion and the second portion.

6. The wear resistant component according to claim 1, wherein
the plurality of support members include a fourth support member,
the fourth support member
has a bar shape including a ninth end, which is the one end exposed from the matrix portion, and a tenth end located within the matrix portion,
a region including the tenth end being a flange larger in cross-sectional area perpendicular to a longitudinal direction than an adjacent region, and
penetrates through the core and contacts the core at the flange.
